(19) United States
(12) Patent Application Publication
(10) Pub. No.: US 2026/0172470 A1
(43) Pub. Date: Jun. 18, 2026

(54) METHODS, ARCHITECTURES, APPARATUSES AND SYSTEMS FOR LOCAL MOBILE METAVERSE WIRELESS/TRANSMIT RECEIVE UNIT SERVICE ENABLERS

(71) Applicant: InterDigital Patent Holdings, Inc., Wilmington, DE (US)

(72) Inventors: Michael Starsinic, Newtown, PA (US); Achref Methenni, Montreal (CA); Xavier De Foy, Kirkland (CA); Rocco Di Girolamo, Laval (CA); Jaya Rao, Montreal (CA); Patrice Hirtzlin, Betton (FR); Loic Fontaine, noyal sur vilaine (FR); Magurawalage Chathura Madhusanka Sarathchandra, London (GB); Renan Krishna, Brighton (GB); Atle Monrad, Froland (NO); Saad Ahmad, Montreal (CA); Michelle Perras, Montréal (CA); Samir Ferdi, Kirkland (CA)

(21) Appl. No.: 19/100,423

(22) PCT Filed: Jul. 31, 2023
(86) PCT No.: PCT/US2023/029074

§ 371 Date: Jan. 31, 2025

Related U.S. Application Data
(60) Provisional application No. 63/394,171, filed on Aug. 1, 2022.

(51) Int. Cl. H04L 67/1001; H04L 67/51

(52) U.S. Cl. CPC H04L 67/1001; H04L 67/51

(57) ABSTRACT

Procedures, methods, architectures, apparatuses, systems, devices, and computer program products for local mobile metaverse service enablers, such as an enabler implemented in a Wireless Transmit/Receive Unit (WTRU). For example, a method may include determining, by a WTRU service enabler hosted by a WTRU, that one or more application clients hosted by the WTRU are interested in available local content. The method may include obtaining, by the WTRU service enabler, the available local content. The method may include providing, by the WTRU service enabler to the one or more application clients, the available local content.

### CROSS-REFERENCE TO RELATED APPLICATIONS

This application claims the benefit of U.S. Provisional Patent Application No. 63/394,171 filed 1 Aug. 2022, which is incorporated herein by reference.

### TECHNICAL FIELD

The present disclosure is generally directed to the fields of communications, software and encoding, including, for example, to methods, architectures, apparatuses, systems directed to local mobile metaverse wireless/transmit receive unit (WTRU) service enablers.

### BACKGROUND

Extended reality (XR) capable devices, such as augmented reality (AR) devices, may allow a user to perceive a digital overlay on the user's local environment. Fifth generation (5G) New Radio (NR) system enhancements would be desirable to address such use cases, such as the enabling of local content.

### SUMMARY

In a representative embodiment, a WTRU may receive configuration information indicating interest information. For example, the interest information may include: (i) one or more application identifiers (IDs) associated with one or more applications of the WTRU and (ii) for each of one or more anchor devices, an anchor device ID and filtering information indicating a first application of the one or more applications is only interested in the corresponding anchor device ID if an orientation of the WTRU relative to the corresponding anchor device and one or more other criteria are satisfied. The WTRU may discover a first anchor device of the one or more anchor devices. The WTRU may apply, for the first anchor device, the filtering information and determine that an orientation of the WTRU relative to the first anchor device and the one or more other criteria are satisfied. The WTRU may transmit information indicating the application ID of the first application and the anchor device ID of the first anchor device to a server. The WTRU may receive, from the server, information indicating a uniform resource indicator (URI) associated with the anchor device ID of the first anchor device. The WTRU may obtain content from a repository using the URI.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example architecture for local mobile metaverse wireless transmit/receive unit service enablers according to an embodiment;

FIG. 3 is flow diagram illustrating an example method implemented in a Wireless Transmit/Receive Unit (WTRU) according to an embodiment;

FIG. 4 is a signaling diagram illustrating an example Interest Configuration, Anchor detection, and Interest Check according to an embodiment;

FIG. 5 is a signaling diagram illustrating an example of Enabler Server based local content detection according to an embodiment;

FIG. 6 is a signaling diagram illustrating an example of rule-based local content availability detection according to an embodiment;

FIG. 7 is a signaling diagram illustrating an example of obtaining local content according to an embodiment;

FIG. 8 is a procedural diagram illustrating an example procedure for a WTRU to obtain content using an anchor device;

FIG. 9 is a procedural diagram illustrating another example procedure for a WTRU to obtain content using an anchor device; and

FIG. 10 is a procedural diagram illustrating still another example procedure for a WTRU to obtain content using an anchor device.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

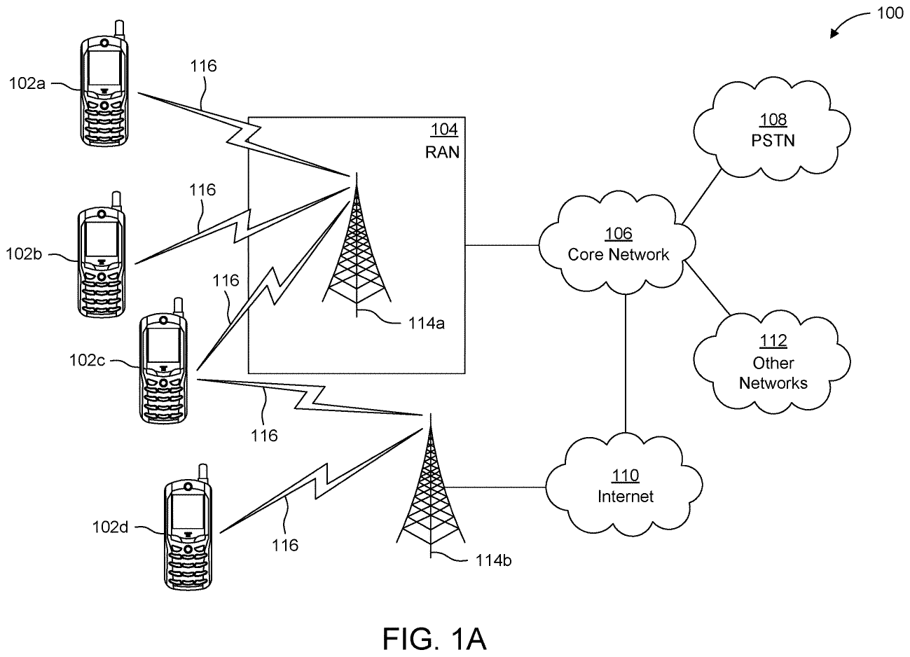

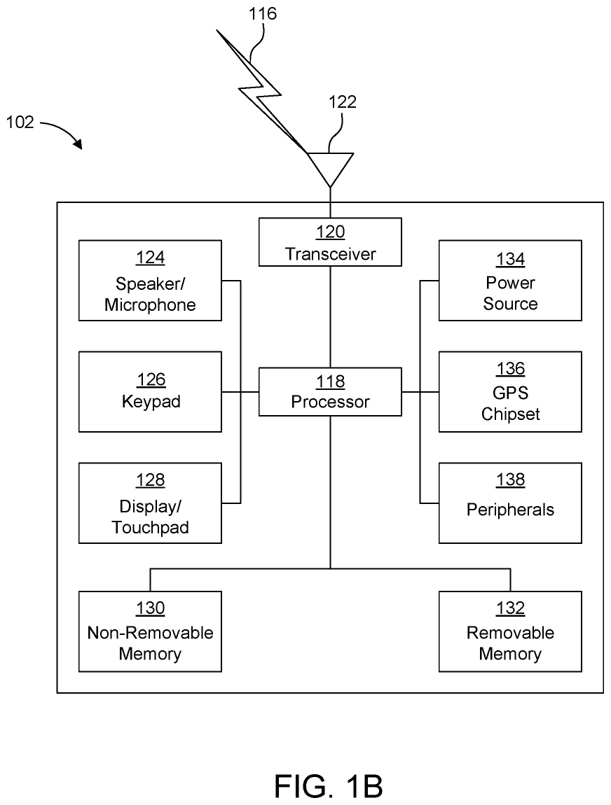

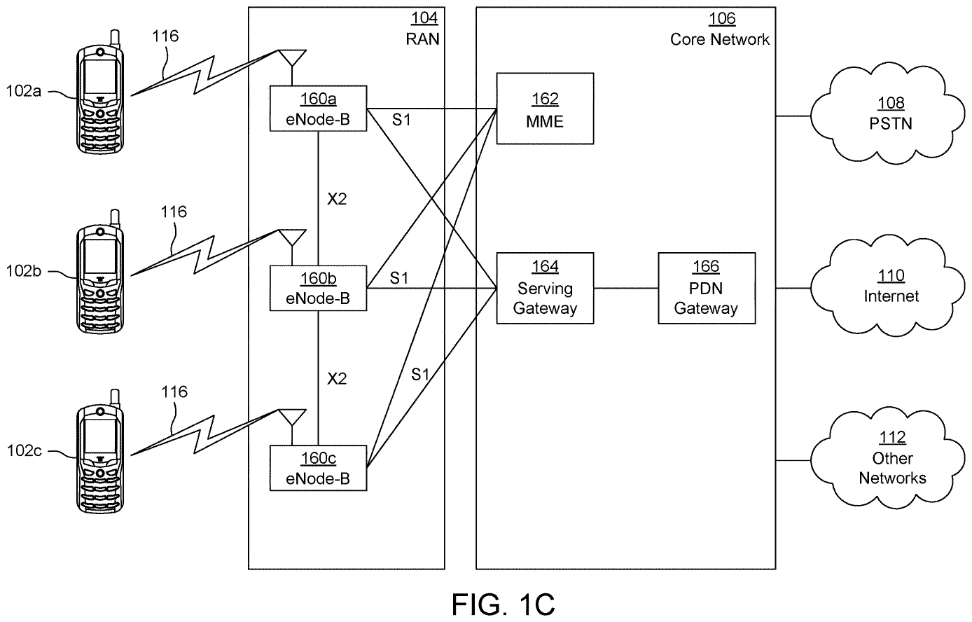

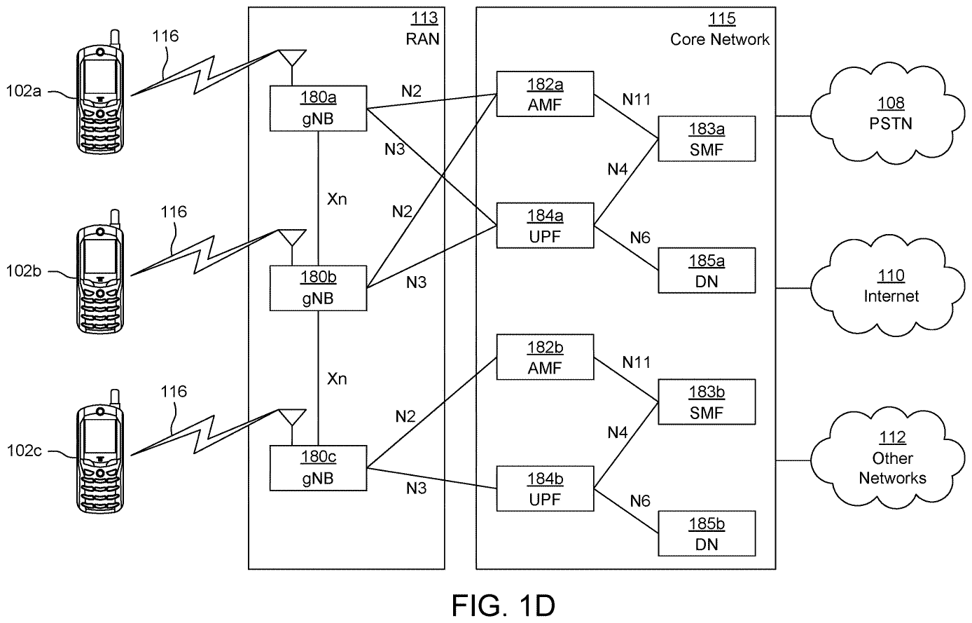

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA20001×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114 b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Wireless Transmit/Receive Unit Service Enablers

The term “hosted on the WTRU” is used in this disclosure. For example, an Application Client may be hosted on the WTRU and called a “WTRU Hosted Application”. A WTRU Hosted Application may be an application that runs in the terminal equipment (TE) part of the WTRU. A WTRU Hosted Application may also be an application that runs on a device that is tethered to the WTRU via a protocol such as Bluetooth, PC5, or Wi-Fi (e.g., AR goggles, a Bluetooth sensor, etc.). The terms WTRU Hosted Application and Application Client are used interchangeably in this disclosure.

### Example Use Cases

In the following example use cases, the following preconditions may apply.

First, a user is using an AR display device such as AR capable glasses, head display, holographic display, smart glasses or optical see-through. The term “AR capable glasses” refers to this collection of devices, for simplicity. The AR capable glasses are tethered to a WTRU that the user carries, or alternatively it may have WTRU capabilities.

Second, the WTRU is capable of performing device-to-device communications using protocols such as WiFi, Bluetooth, and PC5.

Third, the WTRU hosts a WTRU Service Enabler that interfaces with WTRU Hosted Applications and network services. WTRU Hosted Applications include applications that run on tethered devices such as the AR capable glasses. Network Services include Enabler Servers that are hosted by a mobile network operator (MNO) or a 3rd party service provider.

In this use case, the WTRU Service Enabler and an Enabler Server are configured with information about the interests of the user. For example, the interest of the user may include what services WTRU Hosted Applications are associated with, what content WTRU Hosted Applications are associated with, what products the WTRU Hosted Applications are associated with, etc.

As the user travels, the WTRU detects the availability of local content. Local content is information that the WTRU can receive about its local environment. For example, local content can include information about a product that is for sale in a store that is close to the WTRU, information about public transportation services that are nearby, etc. Local content can be associated with a particular location, AR Assets, or data; and local content can be displayed to the user on the AR capable glasses.

The WTRU detects availability of local content by receiving information (e.g. a device identifier or content identifier) via device-to-device communication and providing the information to the WTRU Service Enabler. The WTRU Service Enabler then uses the information to obtain the local content from a memory, from an Application Server, or directly from another device (e.g., the device that is advertising the content or a different device). The local content can then be provided to a WTRU Hosted Application (e.g., an application that runs on the AR glasses) and displayed to the user.

5G System Enhancements are needed in order the enable the use case that is described above.

5G System Enhancements are needed so that the WTRU can detect the availability of local content. Enhancements should describe how the WTRU detects availability and what information is detected. For example, the WTRU may need to detect a device identifier, a device or Service Type, location of the device, etc. The WTRU may travel in environments where there are many devices that advertise content. Thus, mechanisms are needed to allow the WTRU Service Enabler to be configured with information to help it determine what local content is of interest to the user and should be provided to WTRU Hosted Applications and what local content should be filtered from the user.

5G System Enhancements are needed so that a WTRU hosted WTRU Service Enabler can use the detected information to obtain local content. Obtaining local content may involve providing the WTRU Application Client with information so that the WTRU Application Client can obtain the content, support interaction between the WTRU Service Enabler and a WTRU Service Enabler that is hosted in a different device in order to obtain the content, or support interaction between the WTRU Service Enabler and an Application Server in order to obtain the content.

### Example Architecture

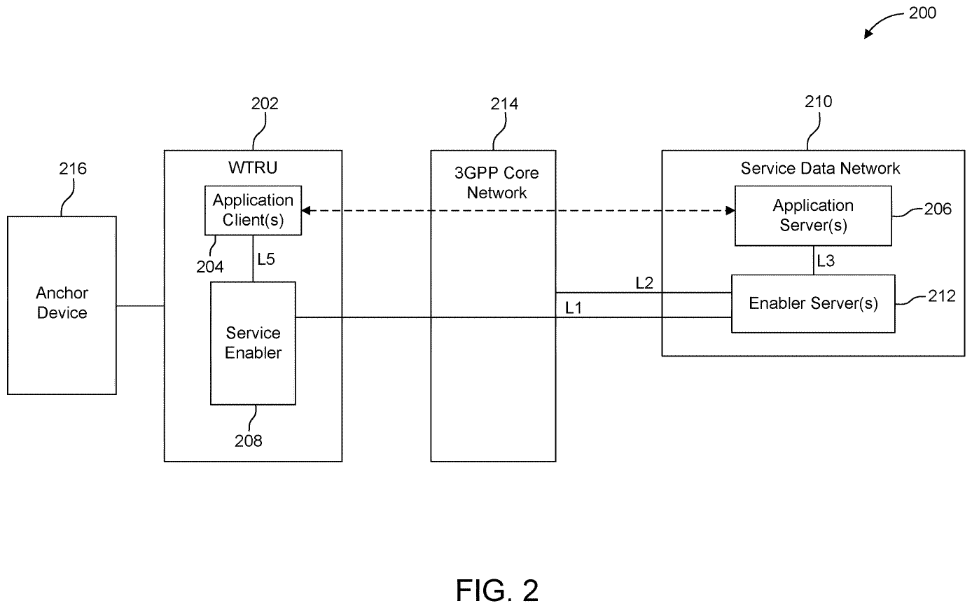

FIG. 2 shows an example architecture 200 that supports Localized Mobile Metaverse Services in the 5G system.

A WTRU 202 may host one or more Application Client(s) 204 that interface with an Application Server 206. For example, the WTRU 202 may be a WTRU 102 that has one or more AR capabilities. This interface with the Application Server 206 may be used for exchange of application data traffic between the Application Client 204 and the Application Server 206. For example, the Application Client 204 may be provided with a uniform resource indicator (URI) to a piece of content and the Application Client 204 may retrieve the content from an Application Server 206. FIG. 2 shows an example where the Application Client 204 communicates with the Application Server 206 via the 3GPP Core Network. However, the Application Client 204 may communicate with the Application Server 206 that is hosted on a WTRU 202 via direct signaling, such as PC5, Wi-Fi, or Bluetooth.

The WTRU 202 may host a WTRU Service Enabler 208 that interfaces with Enabler Server(s) 212. The WTRU Service Enabler 208 provides supporting functions needed for an Application Client(s) 204. The WTRU Service Enabler 208 serves to retrieve configuration information from the Enabler Server 212 to enable the exchange of application data traffic. The WTRU Service Enabler 208 also performs the discovery of available Application Servers 206 in the Data Network. It also supports detecting mobility events. The WTRU Service Enabler 208 interacts with the Application Client(s) 204 via an interface called L-5 interface L5. The WTRU Service Enabler 208 may store information about elements, or devices, in the environment that surrounds the WTRU 202 and make this information available to the Application Clients 204 on the L-5 interface L5. The WTRU Service Enabler 208 functionality that is described in this disclosure may be performed by, or integrated in, a Service Enabler Architecture Layer (SEAL) Client. The functionality, procedures, and messages that are described as part of the L5 interface may be performed on the SEAL-C interface. The functionality, procedures, and messages that are described as part of the LI interface may be performed on the SEAL-UU interface. The SEAL Client, SEAL-C interface, and SEAL-UU interface are defined in 3GPP TS 23.434. Those skilled in the art should be familiar with the SEAL Client, SEAL-C interface, and SEAL-UU interface.

The functionality that this document describes as part of the WTRU Hosted Application Client 202 may be implemented by a vertical application layer (VAL) Client as described in 3GPP TS 23.434. Those skilled in the art should be familiar with the VAL Client.

The functionality described herein as part of the WTRU Hosted Application may be implemented by a VAL Server as described in 3GPP TS 23.434. Those skilled in the art should be familiar with the VAL Server. A Service Data Network 210 may be deployed by a mobile network operator. The service Data Network 210 may host an Enabler Server 212. The Enabler Server 212 may interact with Application Server(s) 206 via an L3 interface. The Enabler Server 212 performs registration procedures with the Application Server(s) 206. The registration procedures may allow Application Servers(s) 206 to provide the Enabler Server 212 with information about content that is available to users. For example, the information may indicate location and position information about a piece of content. The information may further indicate which users or groups of users are allowed to access the content. The information may include security keys or credentials that may be used to access the content and indicate what security procedures are required in order to access the content. The information may include a location where the content can be retrieved from (i.e., a URI), and information related to the content (e.g., content type and actions associated with local content discovery). The information can include a Service Provider Identifier (ID) and a Service Type. The Enabler Server 212 functionality that is described in this document may be performed by, or integrated in, a SEAL Server. The functionality, procedures, and messages that described as part of the L3 interface may be performed on the SEAL-S interface. The SEAL Server and SEAL-S interface are defined in 3GPP TS 23.434.

The Enabler Server 212 may store information about a user's preferences for certain types of content and the ability of a WTRU to retrieve certain types of content. This information may be part of an Interest Filter which is discussed later in this disclosure.

The Enabler Server 212 also includes an L2 interface with the core network 214 that may be used to invoke the service Application Programming Interfaces (APIs) of the core network 214. For example, the L2 interface may be used to invoke a Network Exposure Function (NEF) API that provides the Service Enabler 208 with the WTRU's location, or the network congestion levels in the WTRU's current location. NEF APIs are defined in 3GPP TS 29.522. Those skilled in the art should be familiar with NEF APIs.

The interface between the WTRU Service Enabler 208 and the Enabler Server 212 may be called an L1 interface. The L1 interface may enable the Enabler Server 212 to provide the WTRU Service Enabler 208 with information about content that is available to the WTRU 202 that hosts the WTRU Service Enabler 208.

The Enabler Server 212 and WTRU Service Enabler 208 may execute a procedure where the Enabler Server 212 provides the WTRU Service Enabler 208 with information about the interests of WTRU Hosted Applications 204 that are associated with the Enabler Server's 212 interests. For example, the mobile network operator or an Application Server 206 may configure the Enabler Server 212 with interest information that was obtained from the user and the Enabler Server 212 may provide this information to the WTRU Service Enabler 208. For example, the user (i.e., subscriber) may have used a web portal to configure his or her interests with the network operator. The network operator may store this information in the Enabler Server 212.

The Enabler Server 212 and WTRU Service Enabler 208 may execute a procedure where the WTRU Service Enabler 208 provides Enabler Server 212 with information about the interests of the WTRU Hosted Applications 204. The Enabler Server 212 and WTRU Service Enabler 208 may execute a procedure where the WTRU Service Enabler 208 provides the Enabler Server 212 with information about the interests of the WTRU Hosted Applications 204. For example, the WTRU 202 or a WTRU Application Client/WTRU Hosted Application 204 may provide a graphical user interface (GUI) that allows the user to configure interest information in the WTRU Service Enabler 208 and the WTRU Service Enabler 208 may configure the Enabler Server 212 with interest information that was obtained from the user.

The L1 interface may be a RESTful HTTP interface that is provided via the user plane.

The term “Anchor Device” is used in this document. An Anchor Device 216 may be a device whose position is fixed, or known, relative to other points in the world. As explained herein, the Anchor Device 216 may be a device that transmits a wireless signal that identifies the device so that a second device (e.g., a WTRU) may receive the identifying signal and use the identifying signal to determine that the WTRU 202 is near Anchor Device 216. An Anchor Device 216 may provide an Anchoring position to display AR content and/or may provide an access point to local content.

An Anchor Device's 216 location may be known because it is always assumed to be in a fixed position. Alternatively, the Anchor Device 216 may be a Located WTRU. 3GPP TR 23.700-86 defines a located WTRU as “a WTRU of which the location is known or is able to be known using Uu based positioning. A Located WTRU can be used to determine the location of a Target WTRU using Sidelink Positioning.”

An Anchor Device 216 and WTRU 202 may perform procedures where the WTRU 202 determines its range, or position, relative to the Anchor Device 216. Alternatively, when the Anchor Device 216 is a Located WTRU, the WTRU 202 may detect the nearby presence of an Anchor Device 216 and then request location information for the Anchor Device 216 and use the location information to determine the WTRU's 202 location. The location information for the Anchor Device 216 may be obtained from the Anchor device 216 using PC5 Sidelink Positioning procedures or from the network (i.e., from the Enabler Server 212 or the network's location services). An Anchor Device 216 may also be considered a local access point if it broadcasts identifying information and provides access to content (e.g., via an interface such as PC5, Wi-Fi, or Bluetooth).

### Example Method

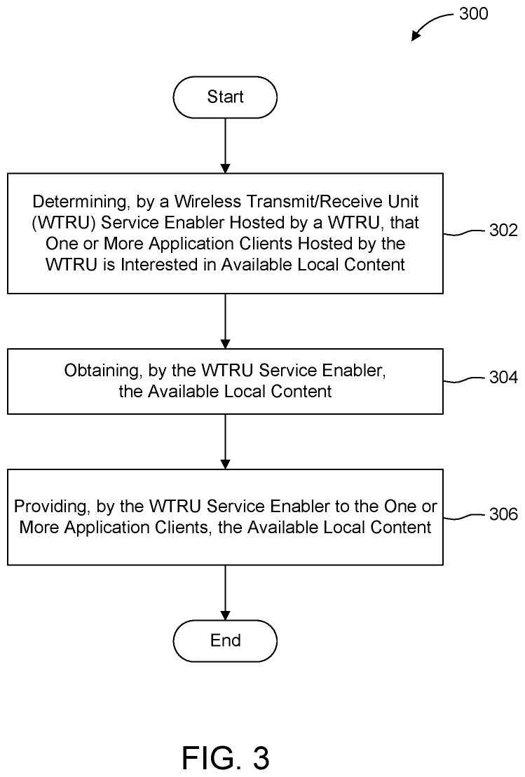

FIG. 3 illustrates an example method 300 implemented in a WTRU 202. Beginning at step 302, the method includes determining, by a WTRU Service Enabler 208 hosted by the WTRU 202, that one or more Application Clients 204 hosted by the WTRU 202 is interested in available local content. At step 304, the method includes obtaining, by the WTRU Service Enabler 208, the available local content. At step 306, the method includes providing, by the WTRU Service Enabler 208 to the one or more Application Clients 204, the available local content.

Method 300 may perform steps 302-306 in various ways. For example, step 302 may include receiving, by the WTRU Service Enabler 208 from an Anchor Device 216, a message indicating that local content is available. Additionally or alternatively, steps 302-306 may include querying an Enabler Server 212, by the WTRU Service Enabler 208, for information regarding the interest of the one or more Application Clients 204 in the available local content. Alternatively or additionally, steps 302-306 may include receiving, by the WTRU Service Enabler 208 from an Enabler Server 212, a message that indicates that local content is available that is of interest to the one or more Application Clients 204. Alternatively or additionally, steps 302-306 may include determining that the one or more Application Clients 204 is capable of using the available local content. Alternatively or additionally, steps 302-306 may include receiving, by the WTRU Service Enabler 208 from an Enabler Server 212, one or more Anchoring rules that indicate one or more Anchoring Devices related to interest of the one or more Application Clients 204 in available local content. Alternatively or additionally, steps 302-306 may include receiving, by the WTRU Service Enabler 208, an Anchor indication from the one or more Anchor Devices 216, and performing, by the WTRU Service Enabler 208 in response to receipt of the Anchoring indication, at least one action specified in the Anchoring rules. Alternatively or additionally, steps 302-306 may include obtaining the available local content from an Enabler Server 212 and providing the available local content directly to the one or more Application Clients 204. Alternatively or additionally, steps 302-306 may include receiving, from an Enabler Server 212, a Uniform Resource Identifier (URI) for retrieving the available local content, and providing the uniform resource identifier to the one or more Application Clients 204.

### Pre-Conditions

The procedures in this disclosure describe how a WTRU Service Enabler 208 in a WTRU 202 may receive a notification about the availability of local content. The notification may come from logic that is internal to the WTRU Service Enabler 208 (e.g., as a result of obtaining an updated WTRU location), or it may come as a notification message from the Enabler Server 212.

The Enabler Server 212 may use collected information to determine whether to send the notification to the WTRU Service Enabler 208. For example, the Enabler Server 212 may be configured with information about the user's interests (e.g., an Interest filter). Interest information, or Interest Filter, may include information about the user's interests, likes, dislikes and previous activity. The Interest information may come from an Application Server 206 or a WTRU Service Enabler 208 that is associated with the WTRU 202. The Interest Information may also be information that was collected by the Enabler Server 212. For example, the Enabler Server 212 may have stored information about services in which the user (i.e., WTRU Service Enabler 208) previously expressed interest. The terms “Interest Information” and “Interest Filter” are used interchangeably in this disclosure. An “Interest Filter” may contain “Interest Information” about the WTRU Hosted Applications.

### Terminology

European Telecommunications Standards Institute (ETSI) Group Specification (GS) Augmented Reality Framework (ARF) 004-2 defines a World Anchor as “fixed position in relation to one or more elements of the real world”. ETSI GS ARF 004-2 also notes that a World Anchor may be attached to a Trackable. ETSI GS ARF 004-2 defines a Trackable as an “element of the real world of which features are available and/or could be extracted.”

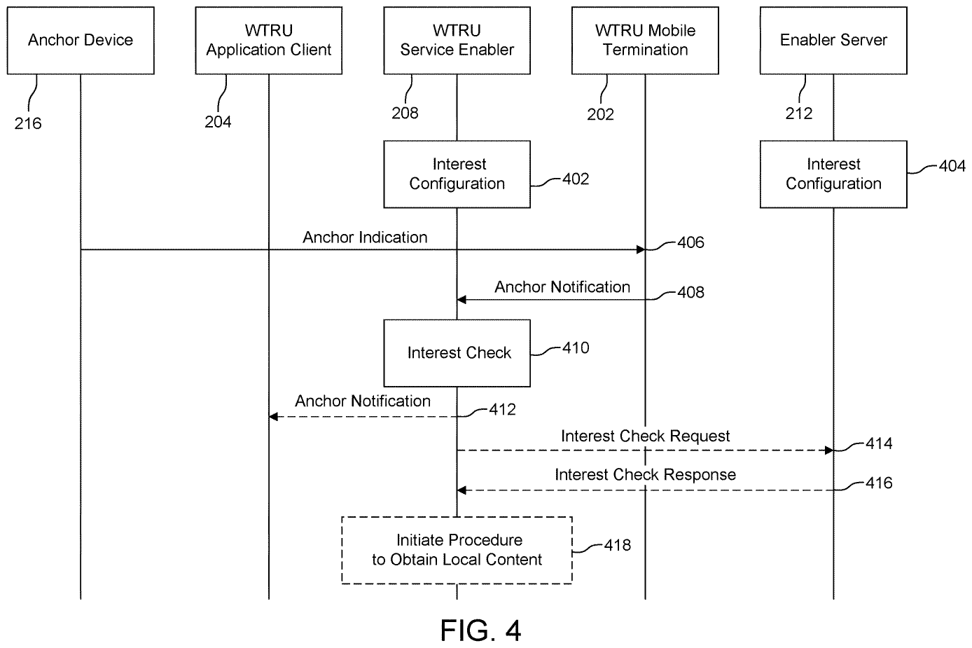

In the example procedures that are shown in this disclosure, the WTRU 202 executes procedures with the Anchor Device 216 via a wireless interface (e.g., PC5, Bluetooth, Wi-Fi, etc.). It should be appreciated that the Anchor Device 216 may be a passive Trackable such as an image, sign, or picture that is detected by the WTRU 202 and used by the WTRU 202 to determine location information. For example, the Anchor Device 216 may be a barcode that is detected by the camera on the WTRU 202. The bar code information may be received by the WTRU Service Enabler 208 (e.g., at 408 of FIG. 4) and used to obtain information about the content and location that is represented by the Trackable (e.g., at 414 and 416 of FIG. 4, discussed further below). The WTRU Service Enabler 208 may use the content and location information from one or more Trackables to build a World Graph that may be accessed by WTRU Hosted Applications. In this sense, a World Graph may be a service that is offered by the WTRU Service Enabler 208 to WTRU Hosted Applications. ETSI GS ARF 004-2 defines a World Graph as a “hierarchy of Trackables and World Anchors representing the real-world knowledge in the World Representation sub-function”. For example, a WTRU Service Enabler 208 may store a World Graph as a resource tree that may be access by WTRU Hosted Applications. Thus, each WTRU Hosted Application would not need to build its own World Graph; the World Graph that is built by the WTRU Service Enabler 208 may be shared by multiple WTRU Hosted Applications. Alternatively, the WTRU Service Enabler 208 and Enabler Server 212 may jointly provide the World Graph. For example, the Enabler Server 212 may host the World Graph and the WTRU Service Enabler 208 may provide the WTRU Hosted Applications access to the World Graph content in the Enabler Server 212.

ETSI GS ARF 003 defines a World Capture function as a function that delivers “information relevant for the localization of the AR device or real objects, or for analyzing the environment of the application. AR systems can embed various sensors aiming at better understanding the real environment as well as the pose (position and orientation) of the AR system or of real objects in this environment required to provide an accurate registration of virtual objects on the real world . . . ”. As described above, a WTRU Service Enabler 208 may provide the World Capture functionality or may interface to World Capture functionality in the WTRU 202. For example, the WTRU Service Enabler 208 may interface to sensors that are built into the WTRU 202 to obtain positioning, image, temperature, movement, and speed information.

ETSI GS ARF 003 defines a World Analysis function as a function that “can estimate the pose or movement of real objects or of the device providing the AR experience. It can also recognize or identify elements present in the real world, or it can reconstruct a 3D map of the real world.”. As described above, a WTRU Service Enabler 208 may provide the World Analysis function.

ETSI GS ARF 003 defines a World Storage function as a function that “delivers information to other functions and subfunctions concerning the representation of the real world (e.g., information for relocalization, 3D object recognition and identification, AR authoring). Additionally, it receives information from other functions to update the representation of the world (e.g., 3D Mapping, 3D Object Recognition), it converts the World Representation (Scene Meshing) or extracts part of this representation (Object 3D Segmentation) for the AR Authoring function.”. As described above, an Enabler Server 212 may provide the World Storage function.

The functionality that is described as being part of the WTRU Service Enabler 208 may be part of the WTRU's operating system, software environment or software library.

3GPP TR 23.700-86 defines a Reference WTRU as a “WTRU who determines a reference plane and reference direction in the Ranging based service and Sidelink positioning.” The Anchor Device 216 that is described in this disclosure may be a Reference WTRU.

3GPP TR 23.700-86 defines an Assistant WTRU as a “A WTRU who provides assistance for Ranging/Sidelink Positioning when the direct Ranging/Sidelink positioning between a Reference WTRU and a Target WTRU cannot be supported.” For example, once the WTRU determines its position relative to the Assistant WTRU, the Enabler Server 212 may provide the WTRU Service Enabler 208 with information about the position of other devices, AR Assets, or real-world elements relative to the Assistant WTRU. This information may be used by the WTRU Service Enabler 208 or WTRU Hosted Applications to determine the WTRU's position relative to the other devices or real-world elements.

ETSI GS ARF 004-2 defines an AR Asset as “any kind of content positioned and oriented in the real world to alter the user's experience” and ETSI GS ARF 004-2 states that “AR Assets are attached and arranged in relation to the real world by using Trackables and/or World Anchors.”

### Detecting Availability of Local Content and Determining Interest

FIG. 4 shows a procedure in which a WTRU Service Enabler 208 receives a message from an Anchor Device 216 that indicates the availability of local content. The WTRU Service Enabler 208 then executes procedures to determine if Application Clients 204 that are hosted on the WTRU 202 are interested in the local content. Interest in the content implies that an Application Client 204 can make use of the local content and should be provided with the content. If the WTRU Service Enabler 208 determines that one or more Application Clients 204 that are hosted on the WTRU 202 are interested in the local content, then the WTRU Service Enabler 208 may initiate a procedure to obtain the local content so that it can be provided to the WTRU Hosted Application.

At 402, the WTRU Service Enabler 208 may be configured with information about what local content is of interest to the Application Clients 204 that are hosted in the WTRU 202. The configuration information can be received from the Applications Clients that are hosted on the WTRU 202 or the configuration information can be received from the Enabler Server 212. For example, a WTRU Hosted Application may be triggered to configure the information in the WTRU Service Enabler 208 when the WTRU Hosted Application is installed. Alternatively or additionally, a WTRU Hosted Application may be triggered to configure the information in the WTRU Service Enabler 208 when the WTRU Hosted Application receives information from the user the from a user interface (e.g., GUI). Alternatively or additionally, a WTRU Hosted Application may be triggered to configure the information in the WTRU Service Enabler 208 when the WTRU Hosted Application is configured by an Application Server 206. For example, an Enabler Server 212 may be triggered to configure the information in the WTRU Service Enabler 208 when the WTRU Service Enabler 208 registers with the Enabler Server 212 or when the Enabler Server 212 receives information configured with interest information by an Application Server 206.

The configuration may include any of the following information.

For example, the configuration information may include an Application Client ID. The identity of the Application Client 204 may be included in the configuration information so that when the local content is detected, or obtained, the WTRU Service Enabler 208 may know what Application Client 204 to notify.

For example, the configuration information may include an Anchor ID. An Anchor ID may be used by the WTRU Service Enabler 208 to detect if an indication that is sent by an Anchor Device 216 might be indicative of local content that is of interest to the Application Client. This information can be used by the WTRU Service Enabler 208 at 410. For example, detection of the Anchor ID may indicate that the associated local content is of interest to the Application and 414 and 416 may be skipped. Alternatively, detection of the Anchor ID may indicate that the WTRU Service Enabler 208 should proceed with 414 and 416 to check if the associated local content is of interest to the Application Client. The WTRU Service Enabler 208 may check if the associated local content is of interest to the Application Client 204 because the WTRU's interest information may be stored in the Enabler Server 212 and the Enabler Server 212 may be configured with information that maps the Anchor ID to content information. The Anchor ID may identity a specific device that is associated with local content that is of interest to the Application Client; in this case 414 and 416 can be skipped. The Anchor ID may identify a type of service, for example restaurant. When the Anchor ID identifies a type of service, 414 and 416 may be performed so that the WTRU Service Enabler 208 can check if the local content is associated with a restaurant that is of interest to the Application Client.

For example, the configuration information may include a Service Provider ID. When the Anchor ID identifies a specific device that is associated with local content, the Service Provider ID may not be needed in the configuration information because the Anchor ID would be sufficient to determine that the Application Client 204 is interested in the associated local content.

For example, the configuration information may include Range Information. Range Information may indicate that the Application Client 204 is only interested in the local content if the WTRU 202 is within a certain range of the Anchor Device 216. Range may be expressed as distance and angle or orientation relative to the Anchor Device 216. Range Information can also include angle or orientation between the AR device and the Anchor Device 216. Orientation between the AR device and Anchor device may be expressed as a distance measurement. Orientation between the AR device and Anchor device may be expressed as a measure of an angle between a point on the AR device and a point on the Anchor Device. Orientation between the AR device and Anchor device may be expressed as an indication of whether the Anchor Device is above or below the AR device. Orientation between the AR device and Anchor device may be expressed as an indication of whether the Anchor Device is behind or in front of the a side of the AR device. This information can be used by the WTRU Service Enabler 208 at 410. For example, the WTRU Service Enabler 208 may determine not to proceed with 414 and 416 if the Anchor Device 216 is not within the indicated range of the Anchor Device 216. The Range Information may be considered a type of filter criteria.

For example, the configuration information may include geo-fencing Information. Geo-fencing Information may indicate the locations of the Anchor Devices 216 that provide local content of interest for the WTRU Application Clients 204 that are only interested in the local content if the WTRU 202 is within a certain range of the Anchor Device 216. This information can be used to help the WTRU 202 determine when to start looking for the Anchor Indications (e.g., at 406) from the Anchor Devices 216.

For example, the configuration information may include other types of filter criteria. For example, the configuration information may include filter criteria that indicate that the Application Client 204 is only interested in the local content at certain times of the day. As another example, the filter criteria may include WTRU trajectory information. Application Client 204 is only interested in local content if the Anchor Device 216 is along the trajectory of the local content. As another example, the filter criteria may include WTRU battery status. Application Client 204 is interested in local content but would prefer not to drain the WTRU battery. This information can be used by the Service WTRU Service Enabler 208 at 410. For example, if the filter criteria does not match the current conditions and the WTRU Service Enabler 208 receives an Anchor Indication, 414 and 416 can be skipped.

At 404, the Enabler Server 212 is configured with information about what local content is of interest to the Application Clients 204 that are hosted in the WTRU 202 (i.e., an Interest Filter). The configuration information can be received from the WTRU Service Enabler 208. For example, the WTRU Service Enabler 208 may send the information to the Enabler Server 212. The information may be sent to the Enabler Server 212 so that the Enabler Server 212 can authorize the WTRU 202 to receive the associated content and so that the Enabler Server 212 is able to detect that the WTRU 202 may be in the vicinity of local content that is of interest. The information that is stored in the Enabler Server 212 may include the same information that was describe above as being stored in the WTRU Service Enabler 208. The Enabler Server 212 is able to independently detect the WTRU's location so that it can notify the WTRU 202 of Anchor Devices 216 that might be in the vicinity of the WTRU 202. The information that is stored in the Enabler Server 212 may include the same information that was described above as being stored in the WTRU Service Enabler 208. Additionally, the information that is stored in the Enabler Server 212 may include an identity of the WTRU Service Enabler 208.

The Enabler Server 212 may obtain the configuration information by invoking an NEF API that obtains the configuration information from the UDR. For example, the configuration information may be stored as part of a WTRU's subscription information or a group of WTRU's subscription information.

SEAL procedures such as the GET VAL WTRU configuration request, which is described in 3GPP TS 23.434, may be used by a Configuration Management Client to send the configuration information to the Enabler Server 212 (i.e., Configuration Management Server).

At 406, the Anchor Device 216 may perform a procedure with the WTRU 202 to indicate the presence of the Anchor Device 216. The procedure may be that the Anchor Device 216 broadcasts its Anchor ID. Additionally, the Anchor Device 216 and WTRU 202 may execute a procedure so that the WTRU 202 can determine the range between the Anchor Device 216 and the WTRU 202. The Range Information may include the distance between the WTRU 202 and the Anchor Device 216, the orientation of the WTRU 202 and the Anchor Device 216, and whether the WTRU 202 is moving closer or further from the Anchor Device 216. This procedure may take place via PC5 signaling.

At 408, the mobile termination (MT) part of the WTRU 202 may send a notification to the WTRU Service Enabler 208 with the Anchor ID and the Ranging Information. An attention (AT) Command may be used to send this information from the MT part of the WTRU 202 to the WTRU Service Enabler 208 which is hosted in the TE part of the WTRU 202.

At 410, the WTRU Service Enabler 208 may use the interest information that was configured at 402 to determine if the Anchor Device 216 is associated with information in which a WTRU Hosted Application Client 204 is interested. As described above, if the interest information includes the Anchor ID that may have been received at 408, then the WTRU Service Enabler 208 may determine to execute 412 and skip 414 to 418. As described above, if the interest information includes filter information, the WTRU Service Enabler 208 may use the filter information to determine that no WTRU Hosted Application Client 204 is currently interested in the content that is associated with the Anchor Device 216 and that 414 to 418 may be skipped. If the WTRU Service Enabler 208 determines that a WTRU Hosted Application Client 204 may be interested in the content that is associated with the Anchor Device 216, then the WTRU Service Enabler 208 may proceed to 414 to further check if the WTRU Hosted Application Client 204 should be provided with the content or only part of the content. For example, an Application Client 204 may be interested in obtaining information about what products are available in a location but not the prices of the products (e.g., to display the available products on a pair of AR goggles and not display the price).

At 412, the information from the Anchor Notification at 408 may be forwarded to the Application Client, which uses the Anchor ID to recognize local content and begin an application layer procedure to obtain the associated content so that it can be displayed to the user (e.g., shown on the user's smart goggles).

At 414, the WTRU Service Enabler 208 may send an Interest Check Request Message to the Enabler Server 212. The Interest Check Request Message may include the WTRU Hosted Application Client ID and the Anchor ID. The Enabler Server 212 may compare the WTRU Hosted Application Client ID and the Anchor ID against the Interest Configuration that the Enabler Server 212 received at 404 to determine if the WTRU Hosted Application should be provided with the content. The Enabler Server 212 may then resolve the Anchor ID to a URI that points to the associated local content.

For example, the Enabler Server 212 may have been configured with resolution information that indicates an association between each Anchor ID and a URI. Alternatively, the Enabler Server 212 may query another server to perform this resolution. The URI may be a URI that points to the associated local content.

At 416, the Enabler Server 212 may send the WTRU Service Enabler 208 an Interest Check Response that indicates to the WTRU if an Application Client 204 should be provided with the local content. This message may include a URI that can be used to retrieve the local content. The Interest Check Response may also include meta data associated with the content (e.g., location information, position information, content type, identity of the associated service provider, required security protocols to access the data, access keys for retrieving the data, etc.)

At 418, the WTRU Service Enabler 208 may execute a procedure to obtain the local content or assist the WTRU Application Client 204 in obtaining the local content. Example procedures for obtaining the local content are discussed later in this disclosure.

### Enabler Server Based Detection of Local Content

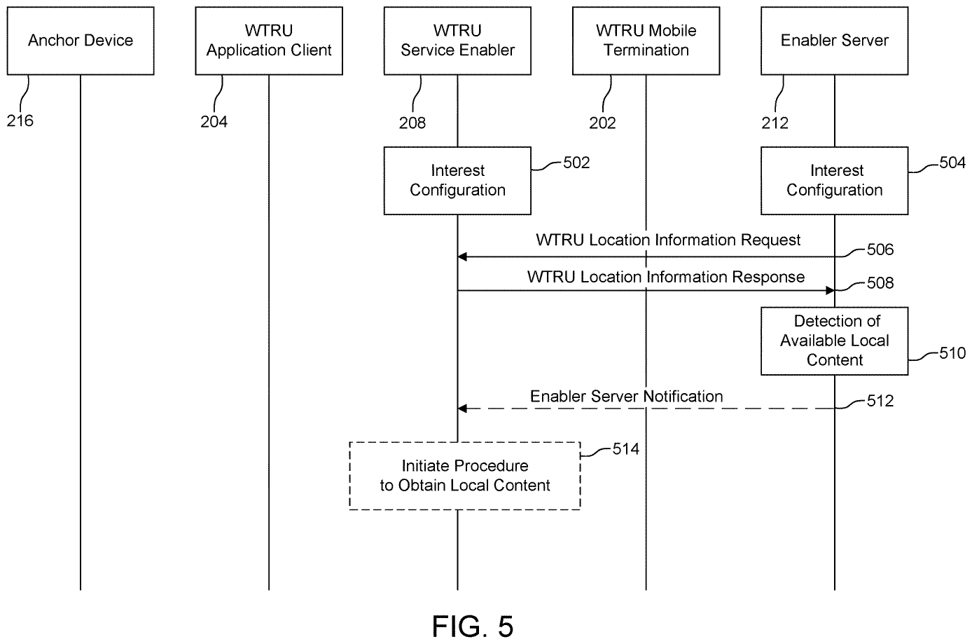

FIG. 5 illustrates procedures that may be performed in a scenario where the detection of local content is performed by the Enabler Server 212. The Enabler Server 212 may be configured to periodically check if it should send an Enabler Server Notification message to the WTRU Service Enabler 208, or the Enabler Server 212 may be configured to check if it should send an Enabler Server Notification message to the WTRU Service Enabler 208 when the Enabler Server 212 receives a notification about a change in the WTRU's state. The Anchor Device 216 does not need to be involved in the procedure of FIG. 5 because the Enabler Server 212 may detect that the WTRU 202 and Anchor Device 216 are in proximity and provide the WTRU 202 with information about the local content. For example, the Enabler Server 212 may receive a notification that the WTRU 202 is in a certain location, that the WTRU's battery is low, that the WTRU 202 is moving in a certain speed range, etc. Upon receiving information about the WTRU's state, the Enabler Server 212 may check if there is local content available to the WTRU 202 that matches the WTRU's interest and determine to send an Enabler Server Notification to the WTRU Service Enabler 208. The Enabler Server Notification may provide the WTRU Service Enabler 208 with information about local content.

At 502 and 504, the WTRU Service Enabler 208 as well as the Enabler Server 212 may be configured with information about the WTRU's interests, similarly to what was discussed in connection with 402 and 404 in FIG. 4.

At 506, the Enabler Server 212 may initiate a procedure to obtain information about the WTRU 202. For example, at 506, the Enabler Server 212 checks the WTRU's location. However, the Enabler Server 212 may initiate other procedures to obtain information about the Enabler Server 212. For example, the Enabler Server 212 may request information about the speed of the WTRU 202 that hosts the WTRU Service Enabler 208, the battery level of the WTRU 202 that hosts the WTRU Service Enabler 208, the network congestion level in the WTRU's location, etc. In some embodiments, instead of being sent to the WTRU 202, this request may be sent to another server or to the 5G Core Network via the NEF. For example, as described in 3GPP TS 23.434, the Enabler Server 212 (e.g., Location Management Server) may send a Location Information Request to a Location Management Client (e.g., WTRU Service Enabler 208).

The Enabler Server 212 can agree with the WTRU Service Enabler 208 on how often to check for the WTRU's location, depending on some parameters such as one or more mobility aspects of the user and/or how many Anchor Devices 216 are in a certain area (e.g., if there are many Anchor Devices 216, it is probably more convenient to refresh WTRU location more often), the range of the Anchor Devices 216 (e.g., Anchors with a small range might experience a refresh of the WTRU location more often to see if there are new Anchors and hence new local content of interest), and perhaps depending on the WTRU Hosted Applications (e.g., checking for a gas station may require less frequent WTRU location updates than checking for a nearby public bathroom).

The Enabler Server 212 can request from the WTRU Service Enabler 208 to provide information about the WTRU location. If suitable location services are available within the 5G system (5GS), then the 5GS may be requested to provide information about WTRU location.

Another trigger to check WTRU location may be if the WTRU Application Host and/or user triggers the WTRU Service Enabler 208 to request a certain local content from the Enabler Server 212. For example, if the user wants to search for public restrooms or if user remembered to ask for a nearby gift shop, such a request can trigger the WTRU side (e.g., WTRU Service Enabler 208) to ask for local content, if available, from the Enabler Server 212.

In this case, this request can trigger provision of WTRU location information to the Enabler Server 212, provided by the WTRU Service Enabler 208 through the specific local content request, or the Enabler Server 212 can simply ask the 5GS to provide the WTRU location.

Another trigger may be related to some status of the WTRU 202 itself. For example, if the WTRU battery level is low, this status can trigger the WTRU Service Enabler 208 to request for local content for the WTRU Application host that reflects “nearby charging station.”. In this example, the user did not actively ask for the content when it occurred but left it to the WTRU Service Enabler 208 to manage and/or trigger this request.

Another trigger might be the WTRU 202 entering configured geo-fenced areas. The WTRU 202 may be configured with this information at 502. Upon entering this location, the WTRU 202 may send an indication to the Enabler Server 212. This message may include the WTRU location or information to help identify the geo-fence. Processing may then continue to 510.

At 508, the WTRU Service Enabler 208 may be provided with the requested information. For example, at 508, the WTRU Service Enabler 208 in the WTRU 202 provides the Enabler Server 212 with the WTRU's location information. However, as explained above, the Enabler Server 212 also may be provided with information about the WTRU's battery level, speed, and network congestion level. This information may be provided to the Enabler Server 212 by the WTRU Service Enabler 208, another Application Server 206, or the NEF of a 5G Core Network.

At 510, the Enabler Server 212 may detect availability of local content for the WTRU 202 using WTRU location information and any other information that was obtained at 508 (e.g., battery information, trajectory, speed, congestion levels) and Interest Configuration. The Enabler Server 212 can use the WTRU location by comparing it to available location points that the Enabler Server 212 has, and initial WTRU location may be mapped onto the closest location point, within a certain distance. Through this mapping, the Enabler Server 212 can determine which possible local content is provided around this location point. For example, if it has some association information between which Anchor Devices 216 are associated with this location point, then the local content associated to these Anchor Devices 216 may be provided to the WTRU 202. For example, at 510, interaction between the Enabler Server 212 and Service Provider may help determine what information should be sent to the WTRU Service Enabler 208. For example, this interaction may allow the Service Provider to control targeted advertisements.

There may be triggers to initiate the Enabler Server 212 to initiate a procedure to provide local content for the user. One of the triggers may be WTRU location. The Enabler Server 212 can use WTRU location in addition to Interest Configuration to determine which local content is available to provide and also should be provided to WTRU 202. The Enabler Server 212 can periodically check the WTRU's location and use a new location, if it changed, to determine available local content.

At this stage, the Enabler Server 212 can approve the detected local content to be provided to the WTRU 202 by performing an Interest Check. Depending on configuration information at the Enabler Server 212, such as Anchor ID, Service Provider ID, some ranging information, and further filter conditions like what time of the day certain WTRU Hosted Application IDs have interest in the local content, the Enabler Server 212 can determine what information to send to the WTRU Service Enabler 208. This configuration information may be similar to 402 of FIG. 4 of this disclosure.

The Enabler Server 212 can determine that there is no available local content for the user at the WTRU location. For example, if the WTRU location is 5 km away from the closest location point, then local content for the WTRU 202 is not available. The Enabler Server 212 can determine available content for WTRU Hosted Applications, but after running an Interest Check, it may determine the available local content is not relevant to the WTRU 202 (e.g., there are some “open gym” places nearby the WTRU 202, but the time of the day is night and WTRU preference for gym suggestion is only in the morning).

At 512, the Enabler Server 212 may send a notification to the WTRU Service Enabler 208 about availability of local content relevant to WTRU Hosted Applications. This notification can include information about the local content available for the WTRU 202, such as Anchor IDs for the Anchor Devices 216 from which the WTRU 202 can obtain content, and perhaps some information on how to obtain such local content. The message may include a URI that can be used to retrieve the local content and the message may include the identity of the WTRU Hosted Application Client(s) 204 that may be interested in the content.

This message can also be a notification that no local content is available or local content is available but not relevant to the WTRU 202 according to an Enabler Server configuration.

In another scenario, the Enabler Server 212 can choose not to perform an Interest Check for the available local content and instead decide to notify the WTRU Service Enabler 208 about the availability of local content with information such as Available Anchor Devices 216 nearby. Then the WTRU Service Enabler 208 can perform the Interest Check on its own to determine whether this content is relevant for the WTRU 202.

The Enabler Server Notification may provide the WTRU Service Enabler 208 with information about local content and may carry the same content as the Interest Check Response message that was described in the procedure of FIG. 4.

At 514, the WTRU Service Enabler 208 may initiate a procedure to obtain the local content. Example procedures for obtaining the local content are discussed later in this disclosure.

### Other Local Content Detection

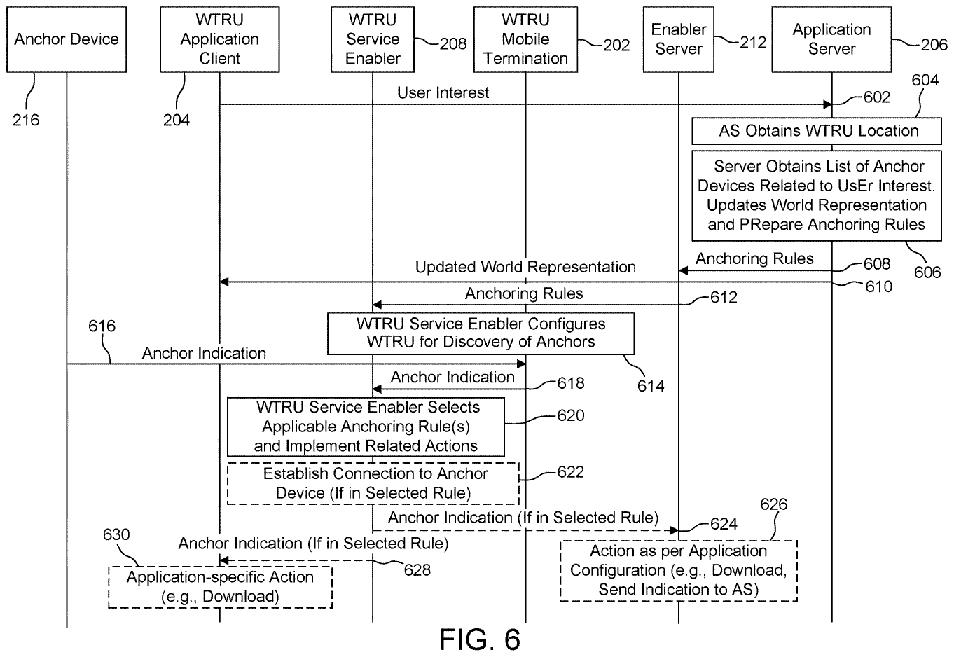

FIG. 6 shows an example of implementation of the procedure described in FIG. 4, where a WTRU Hosted Application configures Anchoring rules in the WTRU Service Enabler 208. Those rules are an exemplary implementation of “interest in local content” described in FIG. 4. Those rules enable Discovery of Anchor Devices 216 by the WTRU 202 and enable linking an Anchor with its related representation in the World Representation. One example of an Anchor Device 216 is a trackable device that can be used by the WTRU Application Client 204 to determine what scene to display on a screen. For example, the screen may be part of a pair of smart goggles and the Anchor Device 216 may be considered a trackable device because the Anchor Device 216 is placed in fixed point in three-dimensional space. The WTRU Application Client 204 may use the presence of the Anchor Device 216 to determine what images to display on the screen above or behind other people or objects that are present in the three-dimensional space with the Anchor Device 216. Another example of an Anchor Device 216 is an access point (e.g., WiFi AP, proximity services (ProSe) device) that provides access to localized content. The WTRU Service Enabler 208 may configure the WTRU 202 for discovering Anchors identified by the Anchoring rules. Upon discovering an Anchor Device 216, the WTRU Service Enabler 208 may select one or more applicable rules and apply the actions defined by this rule.

At 602, the WTRU Application Client 204 may provide the user's interest (i.e., Interest Filter) (e.g., in a product or service, and possibly associated with context information, such as a time limit, time-of-day range where the interest is relevant, etc.) to the Application Server 206.

At 604, the Application Server 206 may obtain the WTRU location (e.g., using a 5G service API, or through the Enabler Server 212). For example, 604 may not be necessary if the Application Server 206 already knows the WTRU location. For example, as described in 3GPP TS 23.434, the Enabler Server 212 (i.e., Location Management Server) may send a Location Information Request to a Location Management Client (i.e., WTRU Service Enabler 208).

At 606, the Application Server 206 may obtain a list of Anchor Devices 216 related to the user's interest. The Application Server 206 may obtain this list from its own database, or from an external service. This procedure may rely on local service providers registering their Anchor Devices 216 with the application or an external service prior to the start of this procedure. The Application Server 206 may update the World Representation for the WTRU Application Client's session, adding the obtained list of Anchor Devices 216, using a world Anchor ID to identify those Anchors. In an example, the world Anchor ID may be a URI. The World Anchor ID may be related to an Anchor Device ID or Anchor service ID, although it may or may not be built using those IDs. The Application Server 206 may prepare Anchoring rules linking the Anchor Device/service ID with the world Anchor ID and with other information elements.

In certain representative embodiments, anchoring rule information elements may include any of: an Anchoring rule ID that is used to identify a rule; a World Anchor ID (i.e., an ID known by the application and associated with the Anchor); an Anchor Device ID; an Anchor service ID; an Anchor type (e.g., Trackable, access point, etc.); a Discovery method (e.g., ProSe, WiFi service discovery, etc.); Access credentials, enabling establishing access with the Anchor Device); Interest Filters (e.g., location information (e.g., cell ID, GPS location, etc.), distance information, time of day Range Information, etc.); and/or Actions, identified with the information elements. For example, action identifying information may include an Action Type that indicates that the WTRU 202 should establish a connection to the Anchor, send an indication to the Enabler Server 212, send an indication to the WTRU Application Client, or download content. For example, action identifying information may include an Actor ID, that identifies a WTRU Service Enabler 208, Enabler Server 212, or a group of WTRU Service Enablers 208 and/or Enabler Servers 212. The Actor ID may identify which entity or entities should perform the action. For example, action identifying information may include additional parameters specific to action types (e.g., URIs for downloading content).

At 608, the Application Server 206 may send Anchoring rules to the Enabler Server 212.

At 610, the Application Server 206 may send an updated World Representation to the WTRU Application Client, including world Anchor IDs that are included in the Anchoring rules. For example, 610 may not be necessary if the World Representation on the WTRU Application Client 204 already includes those world Anchor IDs (e.g., if the WTRU Application Client 204 is already pre-loaded with a complete World Representation in a scenario where the WTRU Application Client 204 always runs when the WTRU 202 is located in a pre-known spot, such as a sporting or gaming venue). The WTRU Application Client 204 may update related information of the WTRU Service Enabler 208 (e.g., in cases where the World Graph is maintained by the WTRU Service Enabler 208). In some systems, the Application Server 206 may send an updated World Representation to the Enabler Server 212, which may send it to the WTRU Service Enabler 208 (e.g., in cases where the World Graph is handled cooperatively by the WTRU Service Enabler 208 and the Enabler Server 212).

At 612, the Enabler Server 212 may send the Anchoring rules to the WTRU Service Enabler 208.

At 614, the WTRU Service Enabler 208 may configure the WTRU 202 for discovering Anchors present in the Anchoring rules. This procedure may include configuring ProSe service discovery, WiFi service discovery, etc. and may use the Discovery method configured in the rule to select the proper method. The WTRU Service Enabler 208 may use the filters of a rule to configure Discovery only if the WTRU 202 is at the configured location for the rule (e.g., within a cell identified by cell ID, or within a certain distance of a GPS location), if the time of day is within the configured time range for the rule, etc.

At 616, at some point an Anchor Device 216 may be discovered by the WTRU 202. An Anchor indication message including an Anchor Device ID or Anchor service ID may be received by the WTRU 202.

At 618, the Anchor indication may be transmitted by the WTRU 202 to the WTRU Service Enabler 208.

At 620, the WTRU Service Enabler 208 may select one or more applicable Anchoring rule (e.g., using the discovered Anchor Device ID and/or Anchor service ID). The WTRU Service Enabler 208 may also use rule filters (e.g., location and time of day) to perform this selection. The WTRU Service Enabler 208 may implement actions specified in the selected Anchoring rule(s), as described as follows.

At 622, assuming a selected Anchoring rule specifies establishing a connection to the Anchor Device 216, the WTRU Service Enabler 208 may trigger the establishment of this connection (e.g., over ProSe, WiFi, etc.). This action may, for example, be limited to some Anchor types (e.g., access point Anchor type). For example, an Anchor type parameter may indicate that the Anchor Device 216 is an Access Point. For example, an Anchor type parameter may indicate the type of radio access technology that the Anchor Point uses to communicate. Examples of radio access technologies are Bluetooth, Wi-Fi, and PC5 based protocols.

Assuming a selected Anchoring rule specifies sending an indication to the Enabler Server 212, the WTRU Service Enabler 208 may send an indication to the Enabler Server 212 at 624. Parameters of the indication message may include an Anchoring rule ID, and/or any Anchoring rule information elements, including world Anchor ID, Anchor Device ID, Anchor service ID, Anchor type, and/or Discovery method. Upon reception of the indication, the Enabler Server 212 may act as per the rule configuration (e.g., it may initiate a download of the content, and/or send an indication to the Application Server 206) at 626.

Assuming a selected Anchoring rule specifies sending an indication to the WTRU Application Client, the WTRU Service Enabler 208 may send an indication to the WTRU Application Client 204 at 628. Parameters of the indication message may include any Anchoring rule information elements, including world Anchor ID, Anchor Device ID, Anchor service ID, Anchor type, and/or Discovery method. Upon reception of the indication, the WTRU Application Client 204 may perform actions based on application-specific logic at 630. For example, the WTRU Application Client 204 may decide to download local content associated with the world Anchor ID, may decide to locate and use a Trackable associated with the world Anchor ID, or other application-specific actions.

### Obtaining Local Content

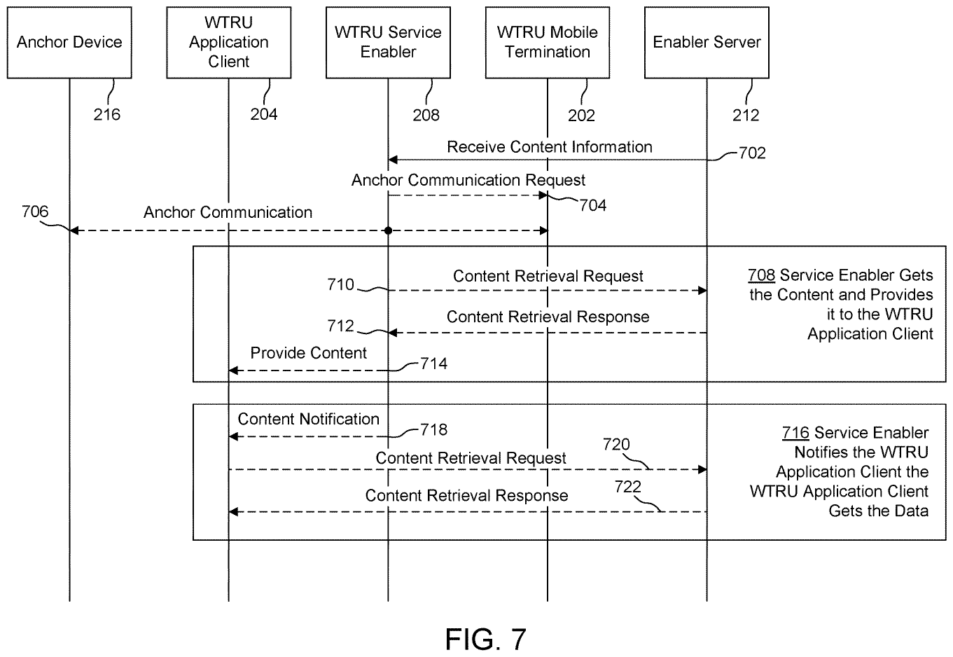

As described above, the WTRU Service Enabler 208 may receive an Interest Check Response or an Enabler Server Notification from the Enabler Server 212. The Interest Check Response or Enabler Server Notification may provide the WTRU Service Enabler 208 with a URI that points to the Local Content that may of interest to a WTRU Hosted Application. The procedure of FIG. 7 illustrates how the information from the Interest Check Response or an Enabler Server Notification can be used to obtain information for the WTRU Application Client 204. The WTRU Application Client 204 may then display the information to the user (e.g., display the information on the user's AR glasses).

At 702, as described above, the WTRU Service Enabler 208 may receive content information from the Enabler Server 212, for example, in an Interest Check Response, such as at 416 in FIG. 4, or an Enabler Server Notification, such as at 512. The response or notification may include the content, a URI that can be used to retrieve the content, or an Anchor ID. For example, if the message at 702 includes the content, then the procedure may skip to 714 and be complete when 714 is complete. For example, if the message at 702 includes an Anchor ID, then the procedure may continue to 704. For example, if the message of 702 includes a URI that can be used to retrieve the content, then the procedure may skip to 710 or 718.

A URI that is received in at 702 (i.e., in an Interest Check Response or Enabler Server Notification) may identify content or identify a storage location for content.

At 704, the WTRU Service Enabler 208 may send the Anchor ID to the MT part of the WTRU and request that the MT part of the WTRU 202 establish communication with the Anchor Device 216. This request may be sent by invoking an AT Command.

At 706, the MT part of the WTRU 202 may establish communication with the Anchor Device 216. For example, establishing communication with the Anchor Device 216 may involve listening for a device that broadcasts the Anchor ID. For example, establishing communication with the Anchor Device 216 may involve transmitting a solicitation request for the Anchor Device 216. For example, the solicitation message may include the Anchor ID. For example, establishing communication with the Anchor Device 216 may involve ProSe Direct Communication or communication through the Uu interface. For example, establishing communication with the Anchor Device 216 may involve performing 802.11aq discovery procedures.

Multiple steps or procedures may be performed at 706. For example, this step may involve discovering the Anchor Device 216, establishing a secure connection with the Anchor Device 216, and then retrieving content from the Anchor Device 216. For example, once communication with the Anchor Device 216 is established, the WTRU Service Enabler 208 may communicate with an Application Client 204 or a WTRU Service Enabler 208 in the Anchor Device 216 in order to retrieve the content. Alternatively, the WTRU Service Enabler 208 may use a URI that was received from the Enabler Server 212 in step 1 to retrieve the specific content in which the WTRU Application Client 204 may be interested. Alternatively, the WTRU Service Enabler 208 may obtain the URI for the content from the Anchor Device 216.

If content was retrieved from the Anchor Device 216 at 706, then the procedure may skip to 714 and may be complete when 714 is complete.

If, on the other hand, a URI was retrieved from the Anchor Device 216 at 706, then the procedure in FIG. 7 may skip to a sub-procedure 708 where the Service Enabler 218 gets the content and provides the content to the WTRU Application Client 2014, or the procedure in FIG. 7 may skip to a sub-procedure 716 where the Service Enabler 208 notifies the WTRU Application Client 204 and then the WTRU Application Client 204 gets the content.

At 710, the WTRU Service Enabler 208 may use the URI that was received at 702 or 706 to request the content from the Enabler Server 212. As an example, FIG. 7 shows that the content is retrieved from the Enabler Server 212. However, it may be that the URI points to content that is stored in a different (i.e., third party) server. Thus, the interaction between the WTRU Service Enabler 208 at 710 may be with a different server than the Enabler Server 212 that participated at 702.

At 712, the Enabler Server 212 may provide the requested content to the WTRU Service Enabler 208.

At 714, the WTRU Service Enabler 208 may provide the content to the WTRU Application Client 204. The WTRU Application Client 204 may then display the content to the user (e.g., on a display 128 or on a peripheral 138, such as AR glasses).

At 718, the WTRU Service Enabler 208 may send a notification to the WTRU Application Client 204 that content has been detected. The notification may include the URI of the content which was received at 702, or 706.

At 720, the WTRU Application Client 204 may use the URI to request the content from the Enabler Server 212. FIG. 7 shows that the content is retrieved from the Enabler Server 212. However, it may be that the URI points to content that is stored in a different (i.e., third party) server. Thus, the interaction between the WTRU Application Client 204 and the Enabler Server 712 at 720 may be with a different server than the Enabler Server 212 that participated at 702.

At 722, the Enabler Server 212 may provide the requested content to the WTRU Application Client 204. The WTRU Application Client 204 may then display the content to the user (e.g., on a display 128 or on a peripheral 138, such as AR glasses).

### Interest Filters

As described in connection with 402 and 404 of FIG. 4, the WTRU Service Enabler 208 and Enabler Server 212 may be configured with information about what local content is of interest to the Application Clients 204 that are hosted in the WTRU. The information may be called an Interest Filter.

The Interest Filter may indicate the Types of Services (e.g., restaurants) that are relevant to each of the WTRU Hosted Applications and sub-types of services (e.g., restaurant type).

The Interest Filter may indicate the identity of Specific Services (e.g., Pizza Restaurant on Main Street) that are relevant to each of the WTRU Hosted Applications.

The Interest Filter may indicate when each piece of content becomes relevant for each of the WTRU Hosted Applications. For example, an Interest Filter in the Enabler Server 212 may indicate that a piece of content should only be sent to the WTRU Service Enabler 208 if the associated Anchor Device 216 is within a certain distance (e.g., 25 m) of the WTRU 202. An Interest Filter in the WTRU Service Enabler 208 may indicate that that the same piece of content should only be sent to a WTRU Hosted Application if the associated Anchor Device 216 is within a smaller distance (e.g., 5 m) of the WTRU 202 and positioned in front of the field of view of AR goggles that are tethered to the WTRU 202. Similarly, the filter may indicate that the content should only be shared if the WTRU 202 meets other criteria, such as speed (e.g., it may be that a WTRU Hosted Application only determines to display certain content to the user in scenarios where the user appears to pause, stop, or linger in a certain area (e.g., near a shop window)).

The WTRU Service Enabler 208 may apply an Interest Filter at 410 of FIG. 4. For example, the filter may indicate whether each WTRU Hosted Application is interested in certain Anchor IDs. Additionally, if the Anchor Notification at 408 includes information such as Ranging Information, then the Interest Filter may be used to “filter out” certain information. For example, the WTRU Service Enabler 208 may determine to only proceed with the procedure of FIG. 4 if the Anchor Device 216 is within a certain range. The Interest Filter may indicate that a WTRU Hosted Application is only interested in content that is associated with an Anchor Device 216 that is within a certain range. Alternatively, the Interest Filter may indicate that the content that is associated with the Anchor Device 216 should be retrieved if the WTRU 202 is within a certain range of the Anchor Device 216 and the content should only be shared with the WTRU Hosted Application if the WTRU 202 is within a closer range of WTRU 202.

The Enabler Server 212 may apply an Interest Filter when determining what content to send to the WTRU Service Enabler 208 at 416 of FIG. 4. For example, an Interest Filter in the Enabler Server 212 may be used to determine if the Interest Check Response should provide content or a URI to content to the WTRU Service Enabler 208.

The WTRU Service Enabler 208 may apply an Interest Filter at 418 of FIG. 4. For example, when a URI to content is received at 416, the Enabler Server 212 may also send meta data, such as location information, a Service Provider Identifier, Range criteria, etc. The WTRU Service Enabler 208 may use the Interest Filter and meta data to determine if the associated content should be retrieved.

As described above and shown in FIG. 4, FIG. 5, FIG. 6, and FIG. 7 Interest Filters may be used to help make the following determinations.

First, if the Server Enabler should request more information about content that is associated with an Anchor Device 216.

Second, if the Enabler Server 212 should provide the WTRU Service Enabler 208 with more information about the content that is associated with the Anchor Device 216.

Third, if the WTRU Service Enabler 208 should retrieve content that is associated with an Anchor Device 216 or perform other actions upon Discovery of an Anchor Device 216, such as sending an indication.

Fourth, if the WTRU Service Enabler 208 should provide the content that is associated with an Anchor Device 216 to a WTRU Hosted Application.

Fifth, if the WTRU Service Enabler 208 should enable Discovery of an Anchor Device 216.

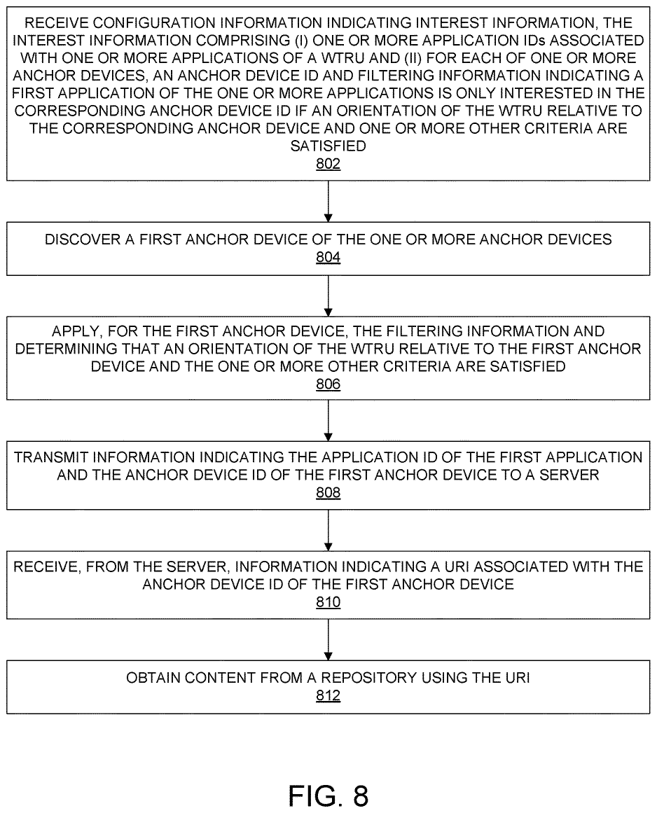

FIG. 8 is a procedural diagram illustrating an example procedure for a WTRU 102 (e.g., a WTRU 202) to obtain content using an Anchor Device 216. In FIG. 8, the WTRU 102 may receive, at 802, configuration information indicating interest information. For example, the interest information may include (i) one or more application IDs associated with one or more applications of the WTRU 102 and (ii) for each of one or more Anchor Devices 216, an Anchor Device ID and filtering information indicating a first application of the one or more applications is only interested in the corresponding Anchor Device ID if an orientation of the WTRU 102 relative to the corresponding Anchor Device 216 and one or more other criteria are satisfied. At 804, the WTRU 102 may discover a first Anchor Device 216 of the one or more Anchor Devices 216. For example, the discovery at 804 may be performed as described herein, such as by using WiFi, Bluetooth, and/or PC5 communication. At 806, the WTRU 102 may apply, for the first Anchor Device 216, the filtering information and determine that an orientation of the WTRU 102 relative to the first Anchor Device 216 and the one or more other criteria are satisfied. At 808, the WTRU 102 may transmit (e.g., based on the determination at 806) information indicating the application ID of the first application and the anchor device ID of the first anchor device to a server (e.g., an Enabler Server 212). At 810, the WTRU 102 may receive, from the server, information indicating a URI associated with the Anchor Device ID of the first Anchor Device 216. At 812, the WTRU 102 may obtain content from a repository using the URI (e.g., the indicated URI from 810). For example, the WTRU 102 may obtain the content as described in FIG. 7.

In certain representative embodiments, the one or more other criteria may be based on any of (i) a time window (e.g., a certain time period), (ii) one or more times of a day (e.g., a set of times), (iii) the first anchor device having an association with a service provider ID, (iii) a distance of the WTRU 102 relative to the first Anchor Device 216 (e.g., within a range or threshold), (iv) a battery status (e.g., above or below a threshold), (v) mobility information of the WTRU 102 (e.g., a speed or trajectory), and/or (vi) an anchor device type of the first anchor device (e.g., what access types are offered by the first Anchor Device 216). Other criteria as described herein may be used.

In certain representative embodiments, the WTRU 102 may provide the obtained content to the application (e.g., as in FIG. 7).

In certain representative embodiments, the WTRU 102 may obtain the content from the repository using the URI such as by obtaining the content from the first Anchor Device 216 based on the URI.

In certain representative embodiments, the WTRU 102 may obtain the content from the repository using the URI such as by obtaining the content from a server (e.g., different than the first Anchor Device), such as an Enabler Server 212, based on the URI.

In certain representative embodiments, the WTRU 102 may obtain the content from the repository using the URI such as by providing the URI to the application and transmitting a request from the application to the repository based on the URI.

In certain representative embodiments, the WTRU 102 may discover the first Anchor Device 216 using broadcast information received from the first Anchor Device 216.

In certain representative embodiments, the WTRU 102 may, after determining that the orientation of the WTRU 102 relative to the first Anchor Device 216 and the one or more other criteria are satisfied, provide a notification to the application that the first Anchor Device 216 is relevant and/or discovered.

In certain representative embodiments, the WTRU 102 may determine that the orientation of the WTRU 102 relative to the first anchor device and a distance of the WTRU relative to the first anchor device, as the one or more other criteria, are satisfied.

In certain representative embodiments, the WTRU 102 may perform ranging to determine the distance of the WTRU 102 relative to the first Anchor Device 216.

In certain representative embodiments, the WTRU 102 may perform discovery of the first Anchor Device 216, such as by receiving (e.g., broadcast) information indicating the anchor device ID of the first Anchor Device and/or a type of the first Anchor Device (e.g., WiFi, Bluetooth, PC5 communications).

In certain representative embodiments, the orientation of the WTRU 102 may corresponds to a field of view (e.g., of a camera, of AR glasses) associated with the WTRU 102.

In certain representative embodiments, the orientation of the WTRU 102 may corresponds to a measure of position of the WTRU 102 relative to the position of the first Anchor Device 216.

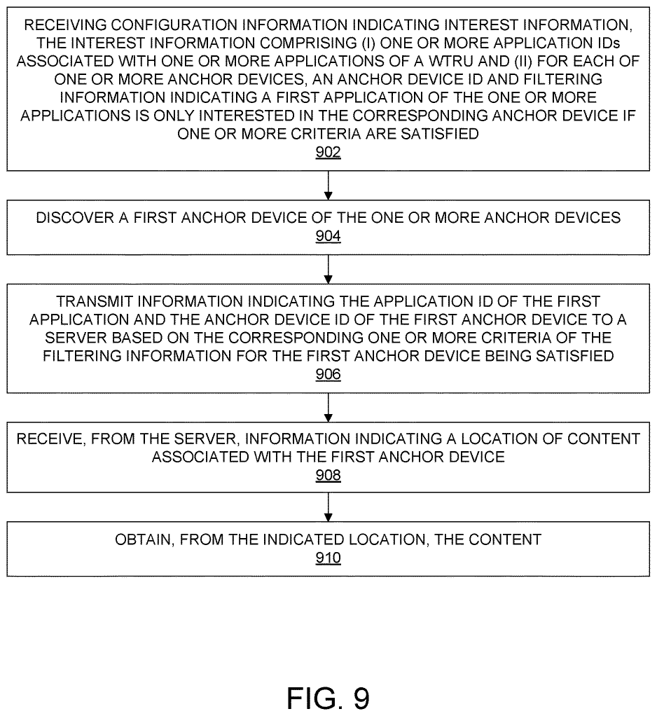

FIG. 9 is a procedural diagram illustrating an example procedure for a WTRU 102 (e.g., a WTRU 202) to obtain content using an Anchor Device 216. As shown in FIG. 9, a WTRU 102 may receive, at 902, configuration information indicating interest information. For example, the interest information may include (i) one or more application IDs associated with one or more applications of the WTRU and (ii) for each of one or more Anchor Device 216, an Anchor Device ID and filtering information indicating a first application of the one or more applications is only interested in the corresponding Anchor Device 216 if one or more criteria are satisfied. At 902, the WTRU 102 may perform discovery of a first Anchor Device 216 of the one or more Anchor Device 216. At 904, the WTRU 102 may transit information indicating the application ID of the first application and the Anchor Device ID of the first Anchor Device 216 to a server (e.g., Enabler Server 212) based on the corresponding one or more criteria of the filtering information for the first Anchor Device 216 being satisfied. At 906, the WTRU 102 may receive, from the server, information indicating a location of content associated with the first Anchor Device. At 908, the WTRU 102 may obtain, from the indicated location, the content. For example, the WTRU 102 may obtain the content as described in FIG. 7.

In certain representative embodiments, the one or more criteria may be based on any of any of (i) a time window (e.g., a certain time period), (ii) one or more times of a day (e.g., a set of times), (iii) the first anchor device having an association with a service provider ID, (iii) a distance of the WTRU 102 relative to the first Anchor Device 216 (e.g., within a range or threshold), (iv) a battery status (e.g., above or below a threshold), (v) mobility information of the WTRU 102 (e.g., a speed or trajectory), (vi) an anchor device type of the first anchor device (e.g., what access types are offered by the first Anchor Device 216), and/or (vii) an orientation of the WTRU 102 (e.g., relative to the first Anchor Device 216).

In certain representative embodiments, the WTRU 102 may perform ranging to determine a distance of the WTRU 102 relative to the first Anchor Device 216.

In certain representative embodiments, an orientation of the WTRU 102 may correspond to a field of view (e.g., of a camera, of AR glasses) associated with the WTRU 102.

In certain representative embodiments, an orientation of the WTRU 102 may correspond to measure of position of the WTRU 102 relative to the position of the first Anchor Device 216.

In certain representative embodiments, the WTRU 102 may obtain and/or provide the content to the application as described herein (e.g., as in FIG. 7).

In certain representative embodiments, the WTRU 102 may discover the first Anchor Device 216 using broadcast information received from the first Anchor Device 216.

In certain representative embodiments, the WTRU 102 may provide, such as after discovering the first Anchor Device 216 at 904, a notification to the application that the first Anchor Device 216 is relevant and/or discovered.

In certain representative embodiments, the WTRU 102 may perform discovery of the first Anchor Device 216, such as by receiving (e.g., broadcast) information indicating the anchor device ID of the first Anchor Device and/or a type of the first Anchor Device (e.g., WiFi, Bluetooth, PC5 communications).

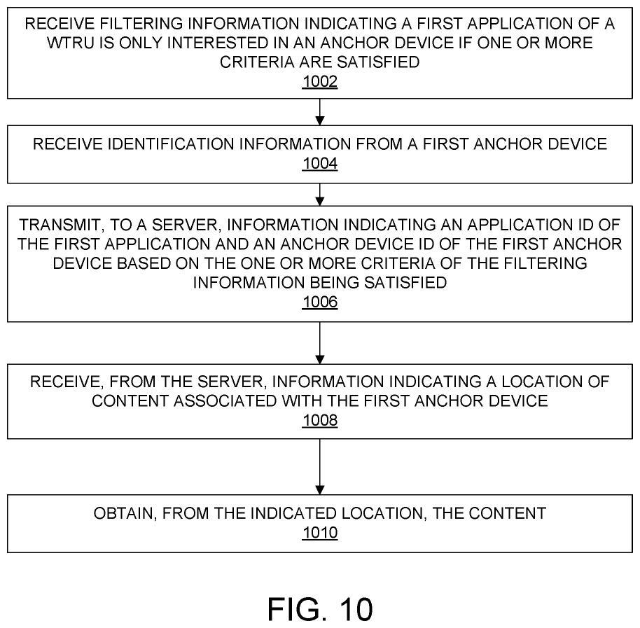

FIG. 10 is a procedural diagram illustrating an example procedure for a WTRU 102 (e.g., a WTRU 202) to obtain content using an Anchor Device 216. In FIG. 10, a WTRU 102 may receive, at 1002, filtering information indicating a first application of the WTRU 102 is only interested in an anchor device (e.g., in general or specific anchor(s)) if one or more criteria are satisfied. At 1004, the WTRU 102 may receive identification information of a first Anchor Device 216. At 1006, the WTRU 102 may transmit, to a server (e.g., Enabler Server 212), information indicating an application ID of the first application and an Anchor Device ID of the first Anchor Device 216 based on the one or more criteria of the filtering information being satisfied. At 1008, the WTRU 102 may receive, from the server, information indicating a location of content associated with the first Anchor Device 216. At 1010, the WTRU 102 may obtain, from the indicated location (e.g., a URI indicated at 1008), the content. For example, the WTRU 102 may obtain the content as described in FIG. 7.

In certain representative embodiments, the filtering information (e.g., received at 1002) may be Interest Filter as described herein.

In certain representative embodiments, the identification information of the first Anchor Device 216 may be received (e.g., from the first Anchor Device 216), such as during a discovery process at 1004.

In certain representative embodiments, a WTRU 102 may perform a procedure (e.g., implement as a method) which includes determining, by a WTRU Service Enabler 208 hosted by the WTRU 102, that one or more Application Clients 204 hosted by the WTRU 102 are interested in available local content. The WTRU Service Enabler 208 may obtain the available local content. The WTRU Service Enabler 208 may provide, to the one or more Application Clients 204, the available local content.

In certain representative embodiments, the WTRU Service Enabler 208 may receive, from an anchoring device, a message indicating that local content is available.

In certain representative embodiments, the WTRU Service Enabler 208 may query an Enabler Server 212 for information regarding interest of the one or more Application Clients 204 in the available local content.

In certain representative embodiments, the WTRU Service Enabler 208 may receive, from the Enabler Server 212, a message that indicates that local content is available that is of interest to the one or more Application Clients 204.

In certain representative embodiments, the WTRU Service Enabler 208 may determine that the one or more Application Clients 204 are capable of using the available local content.

In certain representative embodiments, the WTRU Service Enabler 208 may receive, from an Enabler Server 212, one or more anchoring rules that indicate one or more anchoring devices. For example, the anchoring devices may be related to available local content of interest to the one or more Application Clients 204.

In certain representative embodiments, the WTRU Service Enabler 208 may receive an anchor indication from the one or more anchoring devices. The WTRU Service Enabler 208 may perform, in response to receipt of the anchor indication, at least one action specified in the anchoring rules.

In certain representative embodiments, the anchor indication may correspond to at least one of: (i) an image detected by the WTRU, (ii) a sign detected by the WTRU, (iii) a picture detected by the WTRU, and/or (iv) an anchor indication message including any of an anchoring device identity and/or an anchoring service identity.

In certain representative embodiments, the WTRU Service Enabler 208 may obtain the available local content by receiving the available local content from at least one of the Enabler Server 212 or another enabler server. For example, the available local content may be provided (e.g., directly) to the one or more Application Clients 204.

In certain representative embodiments, the WTRU Service Enabler 208 may obtain and provide the available local content (e.g., indirectly) to the one or more Application Clients 204. For example, the WTRU Service Enabler 208 may receive, from the Enabler Server 212, a URI for retrieving the available local content. The URI may be provided (e.g., transmitted) to the one or more Application Clients 204.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A wireless transmit/receive unit (WTRU) comprising:
a processor, memory, and a transceiver which are configured to:
receive configuration information indicating interest information, the interest information comprising (i) one or more application identifiers (IDs) associated with one or more applications of the WTRU and (ii) for each of one or more anchor devices, an anchor device ID and filtering information indicating that a first application of the one or more applications is only interested in the corresponding anchor device ID if an orientation of the WTRU relative to the corresponding anchor device and one or more other criteria are satisfied,
discover a first anchor device of the one or more anchor devices,
apply, for the first anchor device, the filtering information and determine that an orientation of the WTRU relative to the first anchor device and the one or more other criteria are satisfied,
transmit information indicating the application ID of the first application and the anchor device ID of the first anchor device to a server,
receive, from the server, information indicating a uniform resource indicator (URI) associated with the anchor device ID of the first anchor device, and
obtain content from a repository using the URI.

2. The WTRU of claim 1, wherein the one or more other criteria are based on any of (i) a time window, (ii) one or more times of a day, (iii) the first anchor device having an association with a service provider ID, (iii) a distance of the WTRU relative to the first anchor device, (iv) a battery status, (v) mobility information of the WTRU, and/or (vi) an anchor device type of the first anchor device.

3. The WTRU of claim 1, wherein the processor, the memory, and the transceiver are configured to provide the obtained content to the application.

4. The WTRU of claim 1, wherein the processor, the memory, and the transceiver are configured to obtain the content from the repository using the URI which includes to obtain the content from the first anchor device based on the URI.

5. The WTRU of claim 1, wherein the processor, the memory, and the transceiver are configured to obtain the content from the repository using the URI which includes to obtain the content from a server based on the URI.

6. The WTRU of claim 1, wherein the processor, the memory, and the transceiver are configured to obtain the content from the repository using the URI which includes to provide the URI to the application and transmit a request from the application to the repository based on the URI.

7. (canceled)

8. The WTRU of claim 1, wherein the processor, the memory, and the transceiver are configured to, after determining that the orientation of the WTRU relative to the first anchor device and the one or more other criteria are satisfied, provide a notification to the application that the first anchor device is relevant and/or discovered.

9. The WTRU of claim 1, wherein the processor, the memory, and the transceiver are configured to determine that the orientation of the WTRU relative to the first anchor device and a distance of the WTRU relative to the first anchor device, as the one or more other criteria, are satisfied.

10. The WTRU of claim 9, wherein the processor, the memory, and the transceiver are configured to perform ranging to determine the distance of the WTRU relative to the first anchor device.

11. (canceled)

12. The WTRU of claim 1, wherein the orientation of the WTRU corresponds to a measure of position of the WTRU relative to the position of the anchor device.

13. A method implemented by a wireless transmit/receive unit (WTRU), the method comprising:
receiving configuration information indicating interest information, the interest information comprising (i) one or more application identifiers (IDs) associated with one or more applications of the WTRU and (ii) for each of one or more anchor devices, an anchor device ID and filtering information indicating that a first application of the one or more applications is only interested in the corresponding anchor device ID if an orientation of the WTRU relative to the corresponding anchor device and one or more other criteria are satisfied;
discovering a first anchor device of the one or more anchor devices;
applying, for the first anchor device, the filtering information and determining that an orientation of the WTRU relative to the first anchor device and the one or more other criteria are satisfied;
transmitting information indicating the application ID of the first application and the anchor device ID of the first anchor device to a server;
receiving, from the server, information indicating a uniform resource indicator (URI) associated with the anchor device ID of the first anchor device; and
obtaining content from a repository using the URI.

14. The method of claim 13, wherein the one or more other criteria are based on any of (i) a time window, (ii) one or more times of a day, (iii) the first anchor device having an association with a service provider ID, (iii) a distance of the WTRU relative to the first anchor device, (iv) a battery status, (v) mobility information of the WTRU, and/or (vi) an anchor device type of the first anchor device.

15. The method of claim 13, further comprising:
providing the obtained content to the application.

16. The method of claim 13, wherein the obtaining the content from the repository using the URI includes obtaining the content from the first anchor device based on the URI.

17. The method of claim 13, wherein the obtaining the content from the repository using the URI includes obtaining the content from another server based on the URI.

18. The method of claim 13, wherein the obtaining the content from the repository using the URI includes providing the URI to the application and transmitting a request from the application to the repository based on the URI.

19. (canceled)

20. The method of claim 13, further comprising:
after determining that the orientation of the WTRU relative to the first anchor device and the one or more other criteria are satisfied, providing a notification to the application that the first anchor device is relevant and/or discovered.

21. The method of claim 13, further comprising:
determining that the orientation of the WTRU relative to the first anchor device and a distance of the WTRU relative to the first anchor device, as the one or more other criteria, are satisfied.

22. The method of claim 21, further comprising:
performing ranging to determine the distance of the WTRU relative to the first anchor device.

23. (canceled)

24. The method of claim 13, wherein the orientation of the WTRU corresponds to a measure of position of the WTRU relative to the position of the anchor device.
